(19) United States
(12) Patent Application Publication
(10) Pub. No.: US 2006/0144901 A1
(43) Pub. Date: Jul. 6, 2006

(54) Ribbon-wound bobbin

(75) Inventors: Beverly Ann Bahnken, Andover, NJ (US); Joseph Bahnken, Andover, NJ (US)

Correspondence Address: SUGHRUE MION, PLLC, 2100 PENNSYLVANIA AVENUE, N.W., SUITE 800, WASHINGTON, DC, 20037, US

(73) Assignee: MOREX CORPORATION

(21) Appl. No.: 11/025,071

(22) Filed: Dec. 30, 2004

(51) Int. Cl. A47J 36/02

(52) U.S. Cl. 228/101

(57) ABSTRACT

A ribbon bobbin is disclosed. The ribbon bobbin has a first planar flange, a second planar flange, and a cylindrical post disposed therebetween. The cylindrical post has a first end connected to a center of the first planar flange and a second end connected to a center of the second planar flange. The height of the cylindrical post is not greater than about 1¾ inches. The diameter of the first planar flange and of the second planar flange is not greater than about 2 inches.

### BACKGROUND OF THE INVENTION

1. Field of the Invention

The present invention generally relates to the field of ribbon-storage and dispensing devices. In particular, the present invention relates to an improved, small bobbin on which ribbon is wound.

2. Discussion of Related Art

Scrapbook and card making consumers are always on the look out for new and unique products to use in their projects. If the designs are right, the price is affordable, and the packaging is attractive and appealing, they will buy multiples to keep for future use.

Conventional ribbon is sold in large amounts (more than 12 feet of ribbon per package) and on large spools (more than 3 inches in diameter). Because the large amount of ribbon is significantly more than is needed for a single project and because of the relatively large size of the spools, consumers often require an inconveniently large amount of space for the storage of extra, unused ribbon.

### BRIEF DESCRIPTION OF THE DRAWINGS

These and other features, aspects, and advantages of the present invention will become better understood with reference to the following description, amended claims, and accompanying drawings, which should not be read to limit the invention in any way, in which:

FIG. 1 is a perspective view of a ribbon bobbin according to the present invention.

FIG. 2 is an elevated view of a ribbon bobbin according to the present invention.

FIG. 3 is a top view of a ribbon bobbin according to the present invention.

FIG. 4 is a perspective view of a ribbon bobbin having ribbon wound therearound according to the present invention.

### DETAILED DESCRIPTION OF THE INVENTION

The present invention will be explained in further detail with reference to the accompanying drawings.

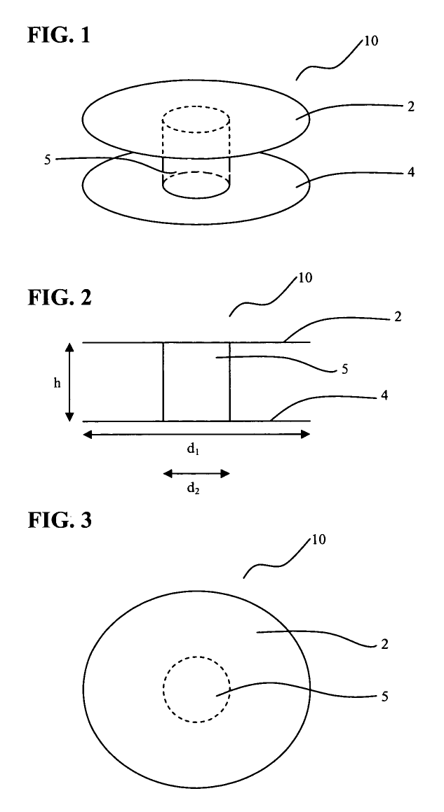

FIGS. 1-3 illustrate different views of an exemplary ribbon bobbin 10 according to the present invention.

As shown a ribbon bobbin according to the present invention comprises a pair of substantially planar, substantially circular flanges, top flange 2 and bottom flange 4, and a substantially central, substantially cylindrical post 5 therebetween. The flanges 2 and 4 and the post 5 may be composed of cardboard or plastic, or any other material as would be understood by one of skill in the art.

The height h of the post, measured between the top flange 2 and the bottom flange 4, is determined by the width of the ribbon to be wound thereon. For example a height of about ⅜ inches or about ⅝ inches to accommodate ribbons of those widths. The height is not greater than about 1¾ inches.

The outer diameter d₁ of the top flange 2 and the bottom flange 4 is approximately 1½ inches, but may vary as understood by one of skill in the art. The outer diameter d₁ of the flanges is not greater than about 2 inches.

The outer diameter d₂ of the post 5 is approximately ½ inch, but may vary as understood by one of skill in the art. The outer diameter d₂ of the post is not greater than about 1¼ inches.

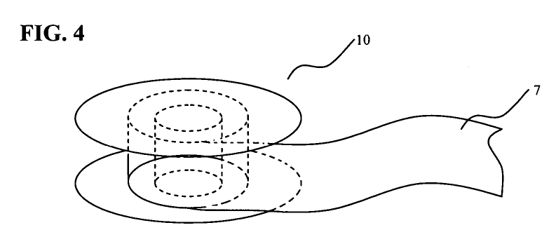

FIG. 4 illustrates an exemplary ribbon bobbin 10 having a ribbon 7 wound therearound. The ribbon may be solid or printed with any of various repetitive designs, such as checks, stripes, flowers, or the like, or various themed designs, such for weddings, birthdays, new babies, sports, Christmas, Halloween, and other holidays, fall and other seasons, vacations, or the like.

Although the above exemplary embodiments of the present invention have been described, it will be understood by those skilled in the art that the present invention should not be limited to the described exemplary embodiments, but that various changes and modifications can be made within the spirit and scope of the present invention.

What is claimed is:

1. A ribbon bobbin, comprising:
a first planar flange;
a second planar flange; and
a cylindrical post having a first end connected to a center of the first planar flange and a second end connected to a center of the second planar flange;
wherein a height of the cylindrical post is not greater than about 1¾ inches.

2. The ribbon bobbin according to claim 1, wherein the height of the cylindrical post is about ⅝ inches.

3. The ribbon bobbin according to claim 1, wherein the height of the cylindrical post is determined by a width of a ribbon wound therearound.

4. A ribbon bobbin, comprising:
a first planar flange;
a second planar flange; and
a cylindrical post having a first end connected to a center of the first planar flange and a second end connected to a center of the second planar flange;
wherein a diameter of the first planar flange and of the second planar flange is not greater than about 2 inches.

5. The ribbon bobbin according to claim 4, wherein the diameter of the first planar flange and of the second planar flange is about 1½ inches.

6. A ribbon bobbin, comprising:
a first planar flange;
a second planar flange; and
a cylindrical post having a first end connected to a center of the first planar flange and a second end connected to a center of the second planar flange;
wherein the height of the cylindrical post is not greater than about 1¾ inches; and
wherein the diameter of the first planar flange and of the second planar flange is not greater than about 2 inches.

7. The ribbon bobbin according to claim 6, wherein:
the height of the cylindrical post is about ⅝ inches; and
the diameter of the first planar flange and of the second planar flange is about 1½ inches.

8. The ribbon bobbin according to claim 6, wherein the height of the cylindrical post is determined by a width of a ribbon wrapped therearound.
